(19) United States
(12) Patent Application Publication
(10) Pub. No.: US 2006/0256014 A1
(43) Pub. Date: Nov. 16, 2006

(54) Frequency agile, directive beam patch antennas

(75) Inventors: Louise C. Sengupta, Ellicott City, MD (US); Ernest Ekelman, Domascus, MD (US); William Brown, Columbia, MD (US)

Correspondence Address: James S. Finn;C/O William Tucker, 14431 Goliad Dr., Box #8, Malakoff, TX, 75148, US

(73) Assignee: Paratek Microwave, Inc.

(21) Appl. No.: 11/349,512

(22) Filed: Feb. 6, 2006

Related U.S. Application Data
(63) Continuation of application No. 10/413,107, filed on Apr. 14, 2003, now abandoned.
(60) Provisional application No. 60/372,741, filed on Apr. 15, 2002.

(51) Int. Cl. H01Q 1/38; H01Q 9/00

(52) U.S. Cl. 343/700 MS; 343/745

(57) ABSTRACT

An embodiment of the present invention provides an apparatus, comprising a frequency agile, directive patch antenna in a phased array with frequency agile elements, wherein the directive patch antenna is capable of generating a main radiation beam that is capable of being steered using electronically controlled phased shifters and wherein at least one tunable capacitors controls the resonant response of individual antenna elements within the phased array.

### CROSS-REFERENCE TO RELATED APPLICATION

This application is a continuation application of U.S. patent application Ser. No. 10/413,107, entitled, “FREQUENCY AGILE, DIRECTIVE BEAM PATCH ANTENNAS”, filed Apr. 14, 2003, which claimed the benefit of priority under 35 U.S.C Section 119 from U.S. Provisional Application Ser. No. 60/372,741, filed Apr. 15, 2002, entitled, FREQUENCY AGILE, DIRECTIVE BEAM PATCH ANTENNAS, by Sengupta et al., assigned to Paratek Microwave, Inc.

### BACKGROUND OF THE INVENTION

The present invention generally relates to tunable antennas, phased array antennas, tunable dielectric capacitors, and semiconductor varactors and more specifically to the aforementioned in frequency agile, directive beam patch antennas.

Scanning, phased array antennas have numerous applications in both the commercial and military markets. The antenna is comprised of smaller antenna elements arranged in a specific pattern and a given differential phase shift in order to steer the main radiation lobe in a certain direction. The phase shift is achieved through the use of either analog or digital electronic phase shifters. Analog phase shifters can achieve a continuous phase shift over the entire 0 to 360 degree range, while needing only a single control voltage. Digital phase shifters often require multiple control voltages in order to shift the various bits in and out of the signal path. Analog phase shifters are typically constructed using tunable elements such as semiconductor varactor diodes, MEMS varactors, or a tunable dielectric capacitor. Semiconductor varactor diodes can provide fast switching times but become very lossy as the frequency increases (i.e. >10 GHz). MEMS varactors have low loss but very poor power handling capability. It would be advantageous to provide the properties of scanning, phased array antennas in a frequency agile, directive beam patch antenna with greatly improved operating characteristics and without the aforementioned shortcomings.

### SUMMARY OF THE INVENTION

The present invention provides a beam steering, frequency agile antenna having low insertion loss, fast tuning speed, high power-handling capability, high IP3 and low cost in the microwave frequency range. More specifically, this is provided for by a frequency agile, directive beam patch antenna, comprising an array of antenna elements, said antenna array elements loaded with tunable dieletric capacitors in order to tune their frequency response; and an electronic phase shifter controlling said array of antenna elements in order to spatially scan the main radiation beam, said tunable dielectric capacitor comprising a substrate having a low dielectric constant with planar surfaces, a tunable dielectric film on said substrate of low loss tunable dielectric material, metallic electrodes with predetermined length, width, and gap distance; and low loss isolation material used to isolate an outer bias metallic contact and a metallic electrode on said tunable dielectric.

In another embodiment of the present invention is provided a frequency agile, directive beam patch antenna, comprising an array of antenna elements, said antenna array elements loaded with tunable dieletric capacitors in order to tune their frequency response; and an electronic phase shifter controlling said array of antenna elements in order to spatially scan the main radiation beam, said tunable dielectric capacitor comprising a micro-electromechanical varactor made in parallel topology, wherein in the parallel plate structure, a first plate is suspended at a distance from a second plate by suspension springs, said distance can vary in response to an electrostatic force between said first and said second parallel plates induced by applying a bias voltage; or in an interdigital topology, wherein moving adjacent fingers comprising the capacitor varies the effective area of the capacitor.

Further, the present invention provides for a method of tuning a patch antenna over a wide frequency range, comprising the steps of loading an array of antenna elements with tunable dieletric capacitors in order to tune their frequency response; and controlling said array of antenna elements with an electronic phase shifter in order to spatially scan the main radiation beam and wherein said tunable dielectric capacitor comprises a substrate having a low dielectric constant with planar surfaces; a tunable dielectric film on said substrate of low loss tunable dielectric material; metallic electrodes with predetermined length, width, and gap distance; and low loss isolation material used to isolate an outer bias metallic contact and a metallic electrode on said tunable dielectric.

### BRIEF DESCRIPTION OF THE DRAWINGS

FIG. 1 depicts patch antennas with multiple tunable Parascan® capacitors;

FIG. 2 is a schematic of a frequency agile, directive beam patch antenna in a phased array with frequency agile elements; and

FIG. 3 is a chart showing return loss versus frequency for a tunable patch antenna of the present invention.

### DESCRIPTION OF THE PREFERRED EMBODIMENT

Inherent in every tunable element is the ability to rapidly tune the response using high-impedance control lines. Paratek, the assignee of the present invention, has developed a tunable material technology, trademarked as Parascan® materials, that enables these tuning properties, as well as, high Q values, low losses and extremely high IP3 characteristics, even at high frequencies. MEM based varactors can also be used for this purpose. They use different bias voltages to vary the electrostatic force between two parallel plates of the varactor and hence change its capacitance value. They show lower Q than dielectric varactors, and have worse power handling, but can be used successfully for some applications. Also, diode varactors could be used to make tunable elements, although with worse performance than dielectric varactors. Tunable dielectric materials are the materials whose permittivity (more commonly called dielectric constant) can be varied by varying the strength of an electric field to which the materials are subjected or immersed. Examples of such materials can be found in U.S. Pat. Nos. 5,312,790, 5,427,988, 5,486,491, 5,693,429 and 6,514,895. These materials show low dielectric loss and high tunability. Tunability is defined as the fractional change in the dielectric constant with applied voltage. The patents above are incorporated into the present application by reference in their entirety.

Parascan® voltage tunable dielectric materials are embodied within software controlled tunable filters, diplexers, matching networks and phased-array antennas, tunable notch filters, null-steer antennas, smart antennas, tunable phase shifters, voltage controlled oscillators (VCO's) and voltage tunable dielectric capacitors. The terms Parascan® voltage tunable capacitors, Parascan® variable capacitors, Parascan™ tunable dielectric capacitors and Parascan® varactors have the same meaning and are interchangeable herein.

The tunable dielectric capacitor in the present invention is made from low loss tunable dielectric film. The range of Q factor of the tunable dielectric capacitor is between 50, for very high tuning material, and 300 or higher, for low tuning material. It also decreases with increasing the frequency, but even at higher frequencies say 30 GHz can take values as high as 100. A wide range of capacitance of the tunable dielectric capacitors is available, from 0.1 pF to several pF. The tunable dielectric capacitor is a packaged two-port component, in which a tunable dielectric can be voltage-controlled. The tunable film is deposited on a substrate, such as MgO, LaAlO3, sapphire, Al2O3 or other dielectric substrates. An applied voltage produces an electric field across the tunable dielectric, which produces an overall change in the capacitance of the tunable dielectric capacitor.

The tunable capacitors with micro-electromechanical technology can also be used and are part of this invention. At least two varactor topologies can be used, parallel plate and interdigital. In the parallel plate structure, one of the plates is suspended at a distance from the other plate by suspension springs. This distance can vary in response to an electrostatic force between two parallel plates induced by applied bias voltage. In the interdigital configuration, moving the fingers comprising the capacitor varies the effective area of the capacitor. MEM varactors have lower Q than their dielectric counterpart, especially at higher frequencies, and have worse power handling, but can be used in certain applications.

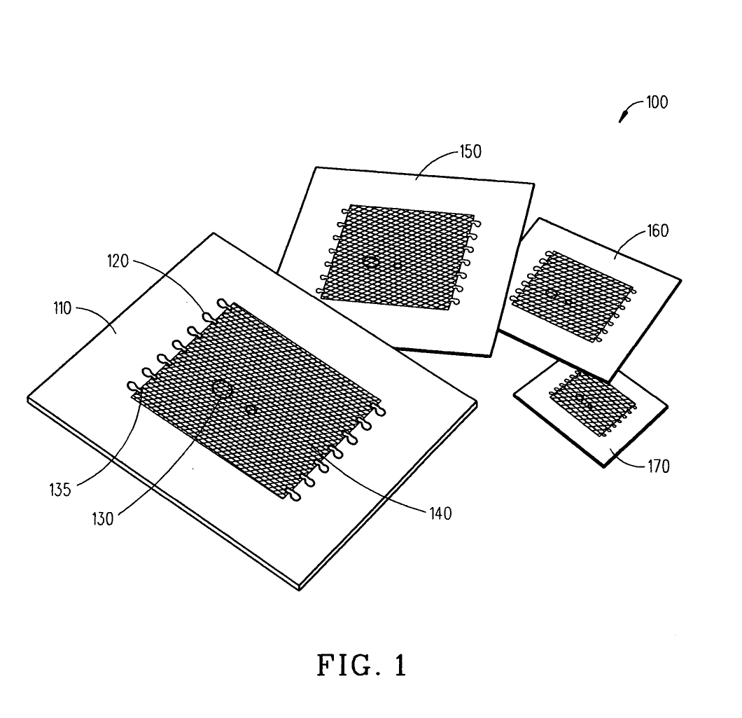

Because of their low profile and ease of construction, a common element used in phased array applications is the microstrip patch. FIG. 1 depicts five patch antennas 100, 140, 150, 160 with multiple tunable Parascan® capacitors 120 (shown on the foremost patch antenna 100). Microstrip patch antennas 100, 140, 150, 160 consist of a very thin metallic strip (or patch) 140 placed a small fraction of a wavelength above a ground plane 110. A dielectric sheet (not shown) referred to as the substrate separates the patch 140 and ground plane 110. Typical patch shapes are square, rectangular, circular etc. They are fed using coaxial lines or can be coupled to a feed via 130 through a slot in the ground plane. Additionally, patches can be single or dual-polarized. An inherent characteristic of patch antennas is their narrow bandwidth, typically less than a few percent. By loading the radiating edges 135 of the patch 140 with a variable capacitance, this narrow band response can be tuned over a much wider frequency range without serious degradation to the VSWR of the patch. Hence the patch itself can be used as a tunable filter, thereby reducing the size and complexity of a system that may require this kind of filtering.

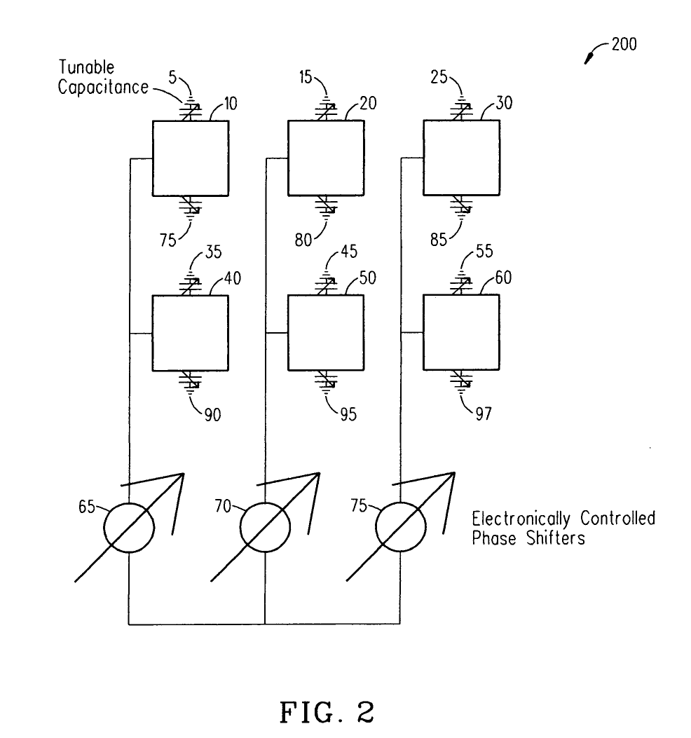

FIG. 2 is a schematic of a frequency agile, directive beam patch antenna 02 in a phased array with frequency agile elements. The main radiation beam is steered using electronically controlled phased shifters 65, 70 and 75. Phase shifter 65 is associated with first the first row of antenna elements 10 and 40. Tunable capacitors 5 and 75 control the resonant response of individual antenna element 10. Tunable capacitors 35 and 90 control the resonant response of individual antenna element 40. Phase shifter 70 is associated with the second row of antenna elements 20 and 50. Tunable capacitors 15 and 80 control the resonant response of individual antenna element 20. Tunable capacitors 45 and 95 control the resonant response of individual antenna element 50. Phase shifter 75 is associated with the third row of antenna elements 30 and 60. Tunable capacitors 25 and 85 control the resonant response of individual antenna element 30. Tunable capacitors 55 and 97 control the resonant response of individual antenna element 60.

Alternatively, MEMS varactors or diode varactors can be used to make tunable elements, although with limited applications. Since the tunable capacitors show high Q, high IP3 (low inter-modulation distortion) and low cost, the tunable antenna in the present invention has the advantage of low insertion loss, fast tuning speed, and high power handling.

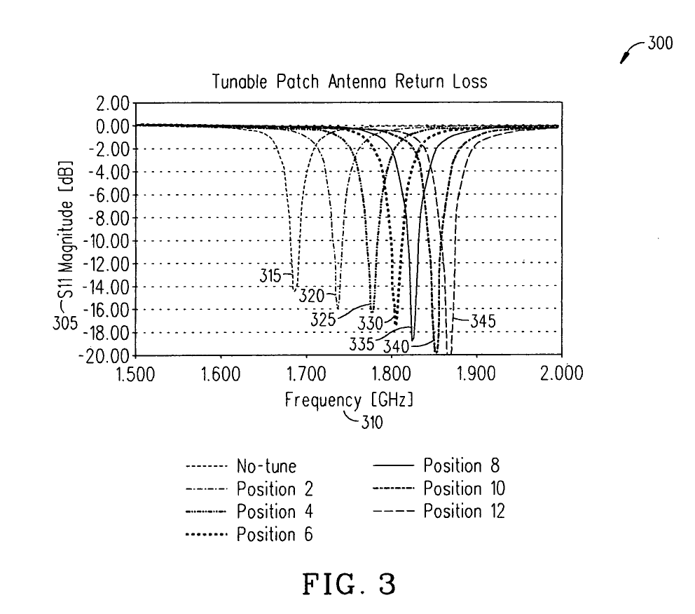

FIG. 3 is a chart 300 showing return loss in dB 305 versus frequency 310 (in this graph in the 1.5 to 2 GHz range) for a tunable patch antenna of the present invention. The graph depicts various tuning positions 315-345 starting with no-tuning 315, following by position 2, 320, position 4, 325, position 6, 330, position 8, 335, position 10, 340 and position 12, 345. As can be seen, varying the tuning position significantly affects the return loss 305 at varying frequencies 310.

While the present invention has been described in terms of what are at present believed to be its preferred embodiments, those skilled in the art will recognize that various modifications to the disclose embodiments can be made without departing from the scope of the invention as defined by the following claims.

What is claimed is:

1. An apparatus, comprising:
a frequency agile, directive patch antenna in a phased array with frequency agile elements, wherein said directive patch antenna is capable of generating a main radiation beam that is capable of being steered using electronically controlled phased shifters and wherein at least one tunable capacitors controls the resonant response of individual antenna elements within said phased array.

2. The apparatus of claim 1, wherein said directive patch antenna is a microstrip patch comprising a thin metallic strip in proximity to a ground plane with a substrate separating said metallic strip and said ground plane; and at least one tunable dielectric capacitor loadings the radiating edges of the patch with a variable capacitance thereby enabling the narrow band response of said patch to be tuned over a wider frequency range without serious degradation to said patch.

3. The apparatus of claim 2, wherein said tunable dielectric capacitor comprises:
a substrate having a low dielectric constant with planar surfaces;
a tunable dielectric film on said substrate of low loss tunable dielectric material;
metallic electrodes with predetermined length, width, and gap distance; and
low loss isolation material used to isolate an outer bias metallic contact and a metallic electrode on said tunable dielectric.

4. The apparatus of claim 2, wherein the Q factor of the tunable dielectric capacitor is between 50, for very high tuning material, and 300 or higher, for low tuning material.

5. The apparatus of claim 3, wherein the capacitance of the tunable dielectric capacitors is from 0.1 pF to three pF.

6. The apparatus of claim 2, wherein said tunable dielectric capacitor comprises a micro-electromechanical varactor.

7. The apparatus of claim 6, wherein said micro-electromechanical varactor is made in parallel topology.

8. The apparatus of claim 7, wherein in the parallel plate structure, a first plate is suspended at a distance from a second plate by suspension springs, said distance can vary in response to an electrostatic force between said first and said second parallel plates induced by applying a bias voltage.

9. The apparatus of claim 6, wherein said micro-electromechanical varactor is made in an interdigital topology.

10. The apparatus of claim 9, wherein in the interdigital configuration, moving adjacent fingers comprising the capacitor varies the effective area of the capacitor.

10. A method, comprising:
tuning a patch antenna over a wide frequency range by loading an array of antenna elements with tunable dieletric capacitors in order to tune their frequency response; and
controlling said array of antenna elements with an electronic phase shifter in order to spatially scan the main radiation beam.

11. The method of claim 10, wherein said tunable dielectric capacitor comprises:
a substrate having a low dielectric constant with planar surfaces;
a tunable dielectric film on said substrate of low loss tunable dielectric material;
metallic electrodes with predetermined length, width, and gap distance; and
low loss isolation material used to isolate an outer bias metallic contact and a metallic electrode on said tunable dielectric.

12. The method of claim 11, wherein the Q factor of the tunable dielectric capacitor is between 50, for very high tuning material, and 300 or higher, for low tuning material.

13. The method of claim 11, wherein the capacitance of the tunable dielectric capacitors is from 0.1 pF to three pF.

14. The method of claim 10, wherein said tunable dielectric capacitor comprises a micro-electromechanical varactor.

15. The method of claim 14, wherein said micro-electromechanical varactor is made in parallel topology.

16. The method of claim 15, wherein in said parallel plate structure, a first plate is suspended at a distance from a second plate by suspension springs, said distance can vary in response to an electrostatic force between said first and said second parallel plates induced by applying a bias voltage.

17. The method of claim 14, wherein said micro-electromechanical varactor is made in an interdigital topology.

18. The method of claim 17, wherein in the interdigital configuration, moving adjacent fingers comprising the capacitor varies the effective area of the capacitor.

19. An apparatus, comprising:
a patch antenna comprising:
an array of antenna elements, said antenna array elements loaded with tunable dieletric capacitors in order to tune their frequency response, said tunable dielectric capacitor comprising: a substrate having a low dielectric constant with planar surfaces; a tunable dielectric film on said substrate of low loss tunable dielectric material; metallic electrodes with predetermined length, width, and gap distance; and low loss isolation material used to isolate an outer bias metallic contact and a metallic electrode on said tunable dielectric; and
an electronic phase shifter controlling said array of antenna elements in order to spatially scan the main radiation beam.

20. The apparatus of claim 19, wherein the Q factor of the tunable dielectric capacitor is between 50, for very high tuning material, and 300 or higher, for low tuning material and the capacitance of the tunable dielectric capacitors is from 0.1 pF to three pF.
